(19) United States
(12) Patent Application Publication
(10) Pub. No.: US 2012/0305490 A1
(43) Pub. Date: Dec. 6, 2012

(54) OIL ABSORBANT POLYOLEFIN FOAM

(75) Inventor: Diana Schroen, Sandia Park, NM (US)

(73) Assignee: General Atomics, San Diego, CA (US)

(21) Appl. No.: 13/153,205

(22) Filed: Jun. 3, 2011

(51) Int. Cl. C02F 1/28; B01D 39/00

(52) U.S. Cl. 210/691; 210/502.1

(57) ABSTRACT

Described herein are polyolefin open cell foam materials that absorb organic liquids or waxes, such as hydrocarbon oil, selectively against water. The polyolefin open cell foam materials are environmentally friendly, have a relatively low bulk density, and can be used in the clean up of oil spills.

### BACKGROUND OF THE INVENTION

1. Field of the Invention

The present invention relates to methods for absorbing an organic liquid, e.g. hydrocarbon oil, by providing a polyolefin open cell foam in the form of a sheet. The polyolefin open cell foam can have a bulk density that is less than about 400 mg/cm³ and an average foam pore size in the range of about 0.2 microns to about 20 microns. The polyolefin open cell foam is contacted with the organic liquid to selectively absorb the organic liquid into the foam pores.

2. Description of the Related Art

Petroleum, or crude oil, is a complex mixture of hydrocarbons used in the manufacture of transportation fuels around the world. However, crude oil and refined fuel spills from damaged off shore oil wells or tanker ship accidents at sea have damaged natural ecosystems throughout the United States and the World. Oil spills at sea are generally much more damaging than those on land, since they can spread for hundreds of nautical miles in a thin oil slick which can also damage the environment adjacent the natural water. As evidenced by recent oil spills, the financial, environmental, and biological damage can be significant. Thus, there is a need for the development of alternative, viable methods of oil spill remediation.

Control of oil spills is difficult, requires ad hoc methods, and often a large amount of manpower. Several types of methods for remediation are commonly employed, including materials that disperse, materials that absorb, booms, and skimmers. Materials that disperse oil accelerate the natural breakdown by using surfactants and organic solvents to thin the oil. However, these chemicals are expensive, can have a degree of toxicity, and can further acerbate the pollution caused by the oil spill. Furthermore, dispersants are often not effective for the purpose of mitigating oil spill damage, as they do not directly remove oil from natural water and may cause the oil to further spread.

Materials that physically separate oil from the water are desirable. For example, booms and skimmers physically corral oil for collection, and can be useful if the oil spill is minimal and confined. Oil absorbent materials are theoretically useful because of their ability to absorb the oil, thus separating it from water. However, the absorbent materials produced thus far have been ineffective for selectively removing the oil on a large scale. Some properties that are considered desirable for good oil absorbing materials are: high uptake capacity, high rate of uptake, and hydrophobicity. Several absorbing materials have been developed that exhibit these properties, such as inorganic powders of clays, lime and silica, cellulose based materials, polymer foams, and silica aerogels. However, these materials can be expensive and generally lack the stability and absorbent power to render them effective for environmentally sound oil spill clean up.

### SUMMARY OF THE INVENTION

The present invention generally relates to an open cell foam material, particularly to a material that selectively absorbs an organic liquid or wax relative to water. Preferably, the open cell foam material absorbs oil and does not absorb water. In particular, the open cell foam preferably comprises a hydrophobic, polyolefin polymer. When the polyolefin open cell foam is brought into contact with an oil and water mixture, the oil can be separated from the water by selective absorption into the pores of the open cell foam. The polyolefin open cell foam can comprise a non-crosslinked polymer. In preferred embodiments, the polyolefin open cell foam material is also environmentally friendly, having very low hazardous material ratings for health, fire, and reactivity.

The storage ability of the polyolefin open cell foam can be tailored to absorb specific organic liquids and waxes, including various oils. For example, based on the viscosity of the oil, the cell size and bulk density of the foam material can be selected to produce an open cell foam that can absorb the oil. Due to their oleophilic nature, the polyolefin open cell foams described herein can also be used for the storage and/or transport of various organic liquids or waxes.

### BRIEF DESCRIPTION OF THE DRAWINGS

FIG. 1 shows oil absorption as a result of increase in weight percentage of polyolefin open cell foam having varying density compared to commercially available booms.

FIG. 2 shows oil absorption as a result of increase in weight of polyolefin open cell foam at varying density over time.

FIG. 3 shows oil absorption as a result of increase in weight of polyolefin open cell foam at varying density over time, including variation with stirring.

FIG. 4 shows the oil absorption with polyolefin open cell foam and compares when the oil and water mixture is stirred versus unstirred.

FIG. 5 shows absorption with polyolefin open cell foam of both oil and dispersants when a mixture of oil, water, and dispersants is provided.

### DETAILED DESCRIPTION OF THE PREFERRED EMBODIMENT

An embodiment provides a method for absorbing an organic liquid. In an embodiment, the method comprises providing a polyolefin open cell foam in the form of a sheet. In an embodiment, the polyolefin open cell foam has a density less than about 400 mg/cm³ and an average foam pore size in the range of about 0.2 microns to about 20 microns. In an embodiment, the method comprises contacting the sheet with the organic liquid. In an embodiment, the method comprises selectively absorbing the organic liquid into the foam pores.

An “organic liquid” as used herein, is any liquid material that comprises an organic compound, which can be any member of the large class of chemical compounds whose molecules contain carbon. Some examples of organic liquids include oils, such as hydrocarbon oils and crude oils. In an embodiment, the organic liquid comprises a hydrocarbon oil. Other examples of organic liquids include dispersants that are commonly used in known oil spill clean up techniques. Dispersants can include organic solvents such as ethylene glycol, dipropylene glycol, 2-butoxyethanol, light petroleum distillates and surfactants such as fatty acid esters and polyethylene glycol esters. An “organic wax” as used herein, is any hydrophobic organic compound that is at least partially solidified at room temperature. Examples of waxes include hydrocarbons having greater than about 12 carbon atoms, e.g., C₁₂-C₅₀ alkanes.

Solubility parameters can be used to provide an open cell foam having a selective affinity for organic liquids, or oils, while also being repellant to water. The polyolefin open cell foam can be provided with a solubility parameter such that it absorbs organic liquids or waxes having similar solubility parameters. In an embodiment, the polyolefin has a Hildebrand solubility parameter δ in the range of about 7.5 (cal^{1/2} cm^{-3/2}) to about 8.5 (cal^{1/2} cm^{-3/2}). In an embodiment, the organic liquid has a Hildebrand solubility parameter δ in the range of about 7.5 (cal^{1/2} cm^{-3/2}) to about 8.5 (cal^{1/2} cm^{-3/2}). The following Table 1 shows Hansen solubility parameters for a polymethylpentene open cell foam made in accordance with the present invention, which are compared to the Hansen solubility parameters of various organic liquids, including some oils.

TABLE 1
Hansen Solubility Parameter Values (δ/MPa^{1/2})

| | Dispersion | | |
|---|---|---|---|
| | Forces | Polar Force | Hydrogen Bonding |
| Polymethylpentene | 15.55 | 0.0 | 0.0 |
| Open Cell Foam | | | |
| ASTM oil #1 | 13.9 | 0.0 | 0.0 |
| ASTM oil #2 | 15.6 | 0.6 | 0.2 |
| ASTM oil #3 | 16.6 | 1.0 | 0.4 |
| 2-butanone | 16.0 | 9.0 | 5.1 |
| Nitromethane | 15.8 | 18.8 | 5.1 |
| Methylene | 18.2 | 6.3 | 6.1 |
| dichloride | | | |
| 2-propanol | 15.8 | 6.1 | 16.4 |
| Ethanol | 15.8 | 8.8 | 19.4 |

As seen in Table 1, the polymethylpentene open cell foam has similar Hansen solubility parameter values to those of the three ASTM oils, and thus, will absorb those liquids. The polymethylpentene open cell foam will also absorb the organic compounds 2-butanone, nitromethane, methylene dichloride, 2-propanol, and ethanol because the hydrogen bonding Hansen solubility parameter values are less than about 20 δ/MPa^{1/2}.

Other liquids that have hydrogen bonding forces greater than 20 δ/MPa^{1/2} are not absorbed. Since dimethyl maleate, glycerol, and water have such high hydrogen bonding values, they will be repelled by the polymethylpentene open cell foam.

TABLE 2
Hansen Solubility Parameter Values (δ/MPa^{1/2})

| | Dispersion Forces | Polar Force | Hydrogen Bonding |
|---|---|---|---|
| Dimethyl maleate | 17.2 | 21.5 | 22.5 |
| Glycerol | 17.4 | 12.1 | 29.3 |
| Water | 12.3 | 31.3 | 34.2 |

Various types of polyolefins can be used in manufacturing the foam. Preferably, the polyolefin is hydrophobic. In an embodiment, the polyolefin comprises a C₂-C₈ alkene recurring unit. In an embodiment, the polyolefin comprises a recurring unit selected from the group consisting of ethylene, propylene, and methylpentene. In an embodiment, the polyolefin comprises a recurring unit of methylpentene. Relatively simple polyolefin recurring units can be used to make the open cell foam. In an embodiment, the polyolefin open cell foam is composed of carbon and hydrogen atoms. The polyolefin can comprise a copolymer. For example, the polyolefin can comprise a recurring unit of methylpentene that is copolymerized with a recurring unit selected from the group consisting of ethylene and propylene.

Polymers that comprise a recurring unit of methylpentene are preferred for the application of absorbing hydrocarbon oil. Such polymers have a high molecular weight, and thus can be manufactured with low bulk density and still have a physical form sufficient to act as an absorbent foam. In an embodiment, the polymer comprises a recurring unit that is selected to provide a combination of high affinity for an organic liquid, e.g. hydrocarbon oil, and insolubility to the organic liquid. For example, a methylpentene recurring unit has a high affinity for hydrocarbon oil, as shown above in Table 1, and it is insoluble in hydrocarbon oil. Furthermore, a polymer comprising a methylpentene recurring unit does not need to be crosslinked to be effective as an oil absorbent open cell foam. Cross-linking the polymer can require additional costs and processing steps. In an embodiment, the polyolefin is non-crosslinked.

Preferably, the polyolefin open cell foam has a low bulk density. The storage ability of the open cell foam can be tailored to a specific viscosity of an organic liquid or wax by adjusting the bulk density and/or the cell size of the foam. The density can be adjusted such that various organic liquids can be absorbed. Increased absorption can be observed as the density decreases, particularly for more viscous organic liquids.

In an embodiment, the density of the polyolefin open cell foam is in the range of about 2 mg/cm³ to about 400 mg/cm³. In an embodiment, the density of the polyolefin open cell foam is in the range of about 20 mg/cm³ to about 250 mg/cm³. In an embodiment, the density of the polyolefin open cell foam is in the range of about 40 mg/cm³ to about 125 mg/cm³. In an embodiment, the density of the polyolefin open cell foam is in the range of about 2 mg/cm³ to about 40 mg/cm³. In an embodiment, the density of the polyolefin open cell foam is in the range of about 30 mg/cm³ to about 60 mg/cm³. In an embodiment, the density of the polyolefin open cell foam is in the range of about 60 mg/cm³ to about 90 mg/cm³. In an embodiment, the density of the polyolefin open cell foam is in the range of about 90 mg/cm³ to about 120 mg/cm³. In an embodiment, the density of the polyolefin open cell foam is in the range of about 120 mg/cm³ to about 150 mg/cm³. In an embodiment, the density of the polyolefin open cell foam is in the range of about 150 mg/cm³ to about 200 mg/cm³. In an embodiment, the density of the polyolefin open cell foam is in the range of about 200 mg/cm³ to about 400 mg/cm³.

Those having ordinary skill in the art, guided by the teachings provided herein, can produce an open cell foam having the targeted bulk density by properly processing a starting polymer material. For example, polymethylpentene can be purchased in its bulk density, pellet form as TPX® Polymethylpentene, which is available from Mitsui Chemicals America, Inc. The polymethylpentene pellets can then be optionally pulverized before being dissolved. Pulverization of the pellets can improve the dissolution time.

A selected amount of polymethylpentene can then be dissolved in an appropriate solvent, such as cyclohexane. The solvent is heated to close to its boiling point (for cyclohexane, about 70° C.) in a heating vessel, and during or after heating, the polymer is added with stirring to speed the dissolution. The heated vessel does not need to be pressurized, but it can be sealed to prevent the loss of solvent, which can be reused. For example, the reaction vessel can be equipped with a condenser to prevent pressure from building and return solvent to the reaction vessel.

The dissolved polymer and the solvent form a solution, which can then be transferred to any size mold for forming the open cell polyolefin foam. For example, the foam can be cast into cylindrical forms of various sizes and thicknesses. The thick cylinders can be sliced to form open cell foam discs of the desired thickness. The foam can also be freeze-dried under vacuum in a mold of desired size.

Before freeze-drying, the solution can be optionally chilled at a temperature below about 0° C., for example, at about −2° C. to about −10° C. Colder temperatures can generally gel the solution faster before the step of freeze-drying occurs. To remove the solvent, the solution (whether gelled or not) can be placed in a refrigerated vessel equipped with a vacuum pump, such as a diaphragm vacuum pump attached to a refrigerated chamber. The refrigerated chamber can be maintained at a temperature in the range of about 0° C. to about 10° C., e.g. in the range of about 0.5° C. to about 7° C. The solvent is sublimated off under vacuum and can then be recaptured for reuse. After the solvent is removed, the bulk density can be determined from the weight of polymer before it was dissolved in the solvent divided by the volume of the solid foam material. In general, the volume of the final foam can be calculated by the total volume of the solution comprising the polymer and solvent, minus about 10% shrinkage that occurs in the freeze drying process. In this embodiment the weight of the foam will be the weight of the polymer.

The open cell foam can be made with various average pore sizes. Larger pore sizes can be obtained by making the open cell foam with a lower bulk density. A larger pore size tends to work better for more viscous organic liquids. However, less viscous organic liquids, such as dispersants, are sufficiently absorbed with smaller pores. In an embodiment, the polyolefin open cell foam has an average foam pore size in the range of about 0.2 microns to about 20 microns. In an embodiment, the polyolefin open cell foam has an average foam pore size in the range of about 0.5 microns to about 15 microns. In an embodiment, the polyolefin open cell foam has an average foam pore size in the range of about 1 micron to about 10 microns.

The polyolefin open cell foam can be used to selectively absorb an organic liquid from water. In an embodiment, the method further comprises contacting the polyolefin open cell foam, e.g., in the form of a sheet, with a mixture that comprises the organic liquid and water, wherein the organic liquid is absorbed selectively into the foam pores relative to the water. The polyolefin open cell foam can absorb the organic liquid without taking up water.

In an embodiment, the polyolefin open cell foam sheet absorbs an amount of water that is less than about 5% by weight, based on the weight of the sheet. In an embodiment, the sheet absorbs an amount of water that is less than about 1% by weight, based on the weight of the sheet. In an embodiment, the sheet absorbs the organic liquid relative to the water with a selectivity greater than about 10 parts organic liquid to 1 part water, by weight. In an embodiment, the sheet absorbs the organic liquid relative to the water with a selectivity greater than about 100 parts organic liquid to 1 part water, by weight. In an embodiment, the sheet absorbs the organic liquid relative to the water with a selectivity greater than about 300 parts organic liquid to 1 part water, by weight.

In an embodiment, the organic liquid comprises spilled oil and the water comprises natural water, either fresh or sea water, and the polyolefin open cell foam sheet is employed as described herein to thereby treat an oil spill. As used herein, a “spilled oil” is any kind of unwanted or undesirable leakage of oil. Treating an oil spill can be performed using a variety of methods, as described herein.

The thickness of the polyolefin open cell foam sheet can vary, and the desired thickness can depend on the conditions in which the sheet will be used. In an embodiment, the sheet has a thickness in the range of about 1 mm to about 250 mm. A thin sheet can be useful to ensure maximum oil absorption at a fast rate. Additionally, thin sheet materials can easily be collected from the water as compared to bulkier materials. In an embodiment, the sheet has a thickness in the range of about 1 mm to about 5 mm.

Other applications may require a polyolefin open cell foam sheet that has a greater thickness, particularly in turbulent water conditions or conditions where oil is present below the surface of the water. In an embodiment, the sheet has a thickness in the range of about 5 mm to about 20 mm. Multiple sheets may be stacked upon one another, with a separating layer in between adjacent sheets, in order to provide additional surface area of polyolefin open cell foam. Such an embodiment may be useful when it is desirable to submerge the open cell foam underwater to absorb oil beneath the water's surface.

After the polyolefin open cell foam sheet has absorbed oil, it can be subject to different processing steps. In an embodiment, the method further comprises delivering the polyolefin open cell foam sheet, after absorption of the oil, to an oil refinery for recycling the hydrocarbon oil. The sheet comprising the polyolefin open cell foam comprises hydrocarbon oil after treatment. The sheet can therefore be picked up from the water via drum, vacuum, oil skimmer, or oil containment boom. The polyolefin open cell foam can be used as an adjunct to booms and can used in situations where a boom is not useful. For example, polyolefin open cell foam can assist booms by being used where the boom has segmented, where two booms meet or where rough water conditions threaten to wash the oil over a boom.

Furthermore, the polyolefin open cell foam can be deployed in ways that a boom cannot such as from an airplane, under water, or in a marsh. Dispersal from an airplane is possible because of the very low weight of the open cell foam. After absorption, an oil skimmer can be used to retrieve the oil soaked foam. It is also possible to absorb oil that is underneath the water surface by weighing the foam down in the water. In an embodiment, the polyolefin open cell foam does not absorb water even after being submerged under the water surface.

In an embodiment, the method further comprises burning the polyolefin open cell foam sheet for disposal. In an embodiment, the polyolefin open cell foam does not have a cover material and thus, it will not have any absorbed water. Thus, the polyolefin open cell foam has the ability to wick oil for burning.

An embodiment provides an oil absorbing device. In an embodiment, the oil absorbing device comprises a polyolefin open cell foam in the form of a sheet. In an embodiment, the polyolefin open cell foam has a density less than about 400 mg/cm³ and an average foam pore size in the range of about 0.2 microns to about 20 microns. In an embodiment, the sheet has a thickness in the range of about 1 mm to about 250 mm. In an embodiment, the oil absorbing device comprises a substrate to which the polyolefin open cell foam is affixed. In an embodiment, the substrate has a flat two-dimensional configuration that has an aspect ratio of at least about 10:1. In an embodiment, the substrate has a flat two-dimensional configuration that has an aspect ratio of at least about 20:1. In an embodiment, the substrate has a flat two-dimensional configuration that has an aspect ratio of at least about 50:1.

The polyolefin open cell foam can be attached to the substrate in a number of ways. In an embodiment, the sheet is in the form of a plurality of polyolefin open cell foam discs. In an embodiment, the plurality of polyolefin open cell foam discs is discontinuous. The use of a substrate for affixing the sheet is optional. For example, the polyolefin open cell foam can be distributed into natural water as a foam unaffixed to any substrate. The polyolefin open cell foam can be self supporting without additional materials, and will selectively adsorb oil and repel water thus is able to be efficiently disposed of by burning and not by disposal in a landfill. The polyolefin open cell foam can also be added to the normal input of an oil refinery. Both the oil and the foam can become additions to the refinery product stream.

The substrate can have a range of widths. A larger width may be desirable where an oil spill is large; however, a smaller width may be desirable if the water conditions are turbulent and control of the oil absorbent device is difficult. In an embodiment, the substrate has a width in the range of about 0.1 m to about 20 m. In an embodiment, the substrate has a width in the range of about 1 m to about 10 m.

Various types of substrates can be used in the oil absorbent device. In an embodiment, the substrate comprises a net. In an embodiment, the polyolefin open cell foam is encapsulated into the substrate.

An embodiment provides a method for cleaning an oil spill. In an embodiment, the method comprises providing an oil absorbing device described herein and contacting the oil absorbing device with a mixture that comprises spilled oil and natural water. In an embodiment, the polyolefin open cell foam pores selectively absorb the spilled oil relative to the natural water. Natural water can include any body of water that an oil spill may occur.

In an embodiment, the oil spill has been previously treated by intermixing a dispersant with the spilled oil, such that the mixture further comprises the dispersant. Dispersant are often applied to lower the viscosity of the oil and to slightly solubilize the oil in water, thus allowing small drops of oil to be stable in the water. The lowering of the viscosity of the oil improves oil absorption into the foam. The increase in hydrophilic nature of the dispersant does not reduce the absorption as the combined hydrogen bonding Hansen solubility parameter of the oil dispersant mixture remains below 20 δ/MPa^{1/2}. Furthermore the polyolefin open cell foam absorbs pure dispersants in those cases where the dispersant's hydrogen bonding Hansen solubility parameter is less than 20 δ/MPa^{1/2}. In an embodiment, the polyolefin open cell foam pores selectively absorb dispersants relative to the natural water.

An embodiment provides a method for storing an organic liquid or wax. In an embodiment, the method comprises providing a container comprising a polyolefin open cell foam. In an embodiment, the polyolefin open cell foam has a density less than about 400 mg/cm³ and an average foam pore size in the range of about 0.2 microns to about 20 microns. In an embodiment, the method comprises placing the organic liquid or wax in the container.

The polyolefin open cell foam can be manufactured according to a variety of methods. Polymer starting material can be purchased and processed to produce an open cell foam having low bulk density and desired pore size. For example, the foam can be produced using a heated reaction vessel, vacuum pumps and refrigeration. The starting material can be placed in a large enclosed heated stirring vessel.

### EXAMPLES

### Calculating Polymethylpentene Open Cell Foam Bulk Density

Polymethylpentene foam was produced in accordance with the process described above to determine the bulk density of the open cell foam material. Two examples are provided below in Table 3.

TABLE 3
Calculation of Bulk Density Based Upon Manufacturing Conditions

| | Weight (g) | Density (g/mL) | Volume (mL) |
|---|---|---|---|
| Example 1 | | | |
| Cyclohexane | 593.10 | 1.10 (as frozen) | 539.18 |
| Polymethylpentene | 4.96 | 0.84 | 5.93 |
| Total Weight | 598.06 | | |
| Total Volume | | | 545.12 |
| Example 2 | | | |
| Cyclohexane | 593.10 | 1.10 (as frozen) | 539.18 |
| Polymethylpentene | 218.37 | 0.84 | 261.53 |
| Total Weight | 811.47 | | |
| Total Volume | | | 800.71 |

The density of the polymethylpentene open cell foam in Example 1 was about 9.09 mg/cm³ and the density after calculating the shrinkage (about 10%) was about 10.0 mg/cm³. The density of the polymethylpentene open cell foam in Example 2 was about 273 mg/cm³ and the density after calculating the about 10% shrinkage was about 300 mg/cm³. As such, the desired bulk density of the open cell foam material can be obtained by properly weighing polymer starting materials and the solvent.

### Oil Absorption of Polymethylpentene Open Cell Foam

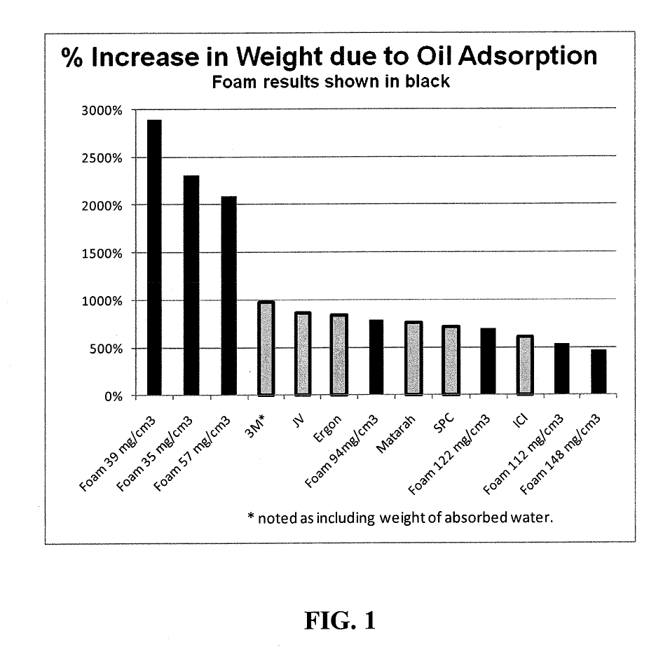

The oil absorption, based on the increase in weight due to oil, was measured to determine the percentage of weight increase that is obtained using the polymethylpentene open cell foam described above at varying bulk densities. The measured data was compared to published data from the Environmental Geology and Water Science Journal (Vol 17, No. 2, 157-166). The data reports on scientifically run analysis of oil absorption using commercially available booms from Ergon, Inc. (ERGON), Industrial Cleanup Inc. (ICI), JV Manufacturing (JV) Matarah Inc. (Matarah), Sorbent Products Company (SPC), and 3M (3M). Polymethylpentene open cell foams, having varying densities, were placed in a mixture that comprised hydrocarbon oil and water. The weight gain of the foam material was then measured. The results are provided in FIG. 1.

As shown in FIG. 1, polymethylpentene open cell foam absorbs oil much better than known materials at varying bulk densities. In particular, weight increases of over 2000% were observed with polymethylpentene open cell foams having a bulk density in the range of about 30 mg/cm³ to about 60 mg/cm³. Higher density foams, e.g. having a bulk density that is greater than about 90 mg/cm³, also absorb substantial amounts of oil. The higher density foams are very physically robust and machinable, and still absorb five times their weight in oil. The polymethylpentene open cell foams did not absorb water. However, the booms were subject to water absorption. For example, the 3M boom absorbed about 5% water and the weight of the water was included in the absorbed oil weight.

### Oil Absorption Rate of Polymethylpentene Open Cell Foam

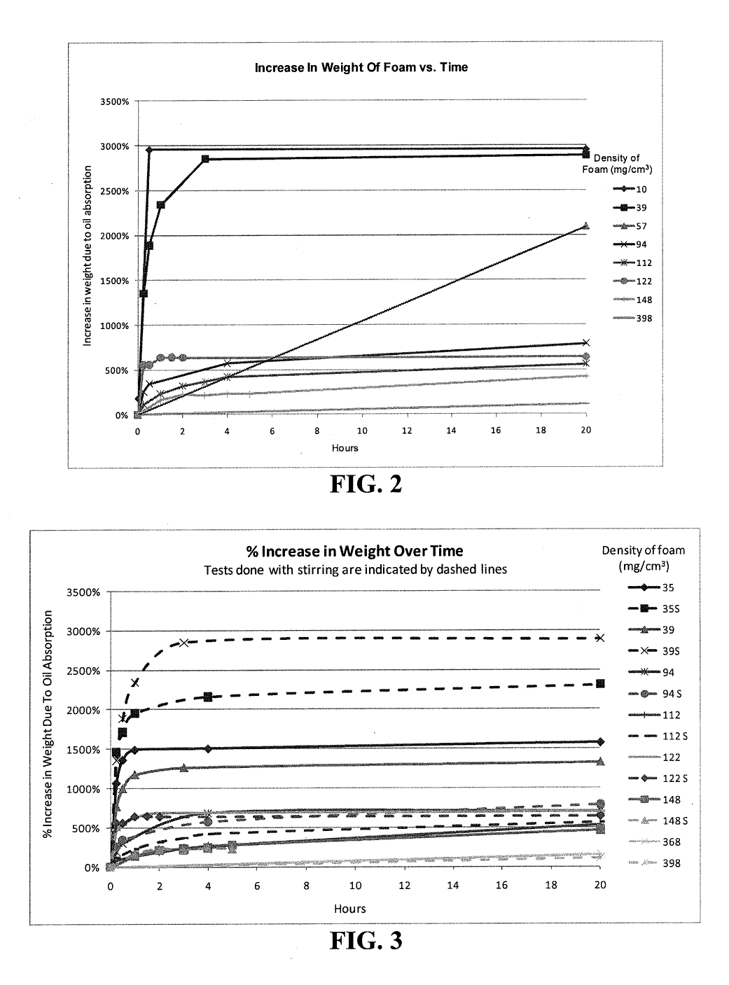

As noted above, the density of the polymethylpentene open cell foam factors into the maximum amount oil absorption. It also factors into the rate of absorption. Polymethylpentene open cell foams, having varying densities, were placed in a mixture that comprised hydrocarbon oil and water, and the weight gain for each was measured over time. The results are shown in FIGS. 2 and 3. Lower density foams absorb faster, as shown in FIG. 2. The 10 mg/cm³ foam absorbs very rapidly (fully saturated in 25 minutes). Very large weight increases over a short period of time were also observed with open cell foams having higher bulk density. FIG. 3 also shows the effect of stirring when the open cell foam is in the oil and water mixture. Samples that were stirred have an “s” adjacent to the foam density. Stirring generally increased the rate of absorption.

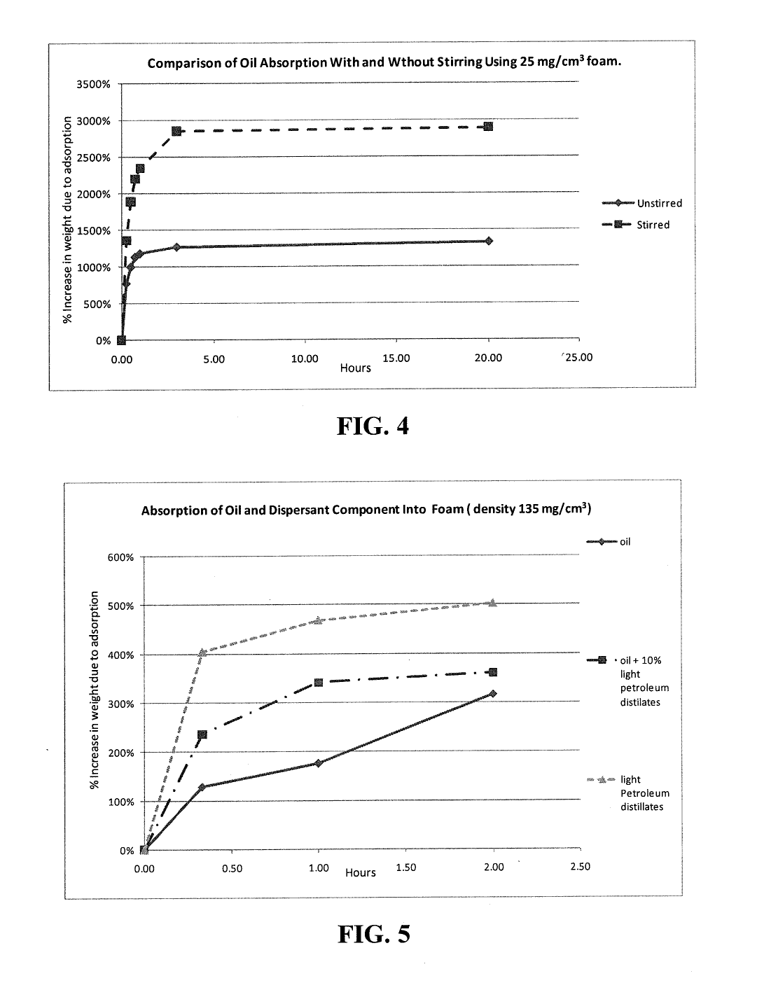

FIG. 4 further shows the effect of stirring the mixture of hydrocarbon oil and water using two samples of polymethylpentene open cell foam having a density of about 25 mg/cm³. The first sample was run under quiescent conditions and the second sample was stirred. Faster oil absorption was observed when the water-oil mixture was stirred, as shown in FIG. 4. The stirring condition is more representative of the conditions that one would expect in the natural environment, since natural water environments typically have a degree of turbidity.

### Dispersant Absorption of Polymethylpentene Open Cell Foam

The polymethylpentene foam also collects dispersants, which are often intermixed with the oil spills in known treatment methods. Polymethylpentene foam was tested with the major component of a dispersant, Corexit® EC9500A petroleum distillate, hydrotreated light [CAS No. 64742-47-8] and with this component combined with 10% oil. The foam had a bulk density of about 135 mg/cm³. The results are shown in FIG. 5. In both cases the absorption rate into the foam was increased. The effectiveness of a dispersant can be affected by the salinity of the water while no such affect has been seen with the effectiveness of the oil absorbing foam.

### Safety of Polymethylpentene Open Cell Foam

The National Fire Protection Association (NFPA) Hazard Ratings of the polymethylpentene open cell foam was also determined and compared to dispersants known in the field of oil spill clean up. As seen in Table 4 below, the polymethylpentene open cell foam, which absorbs and removes oil, has equal or better Hazard Ratings compared to the dispersants, which do not remove oil.

TABLE 4
NFPA Hazard Ratings

| NFPA Rating | Health | Fire | Reactivity |
|---|---|---|---|
| Polymethylpentene | 1 | 1 | 0 |
| Open Cell Foam | | | |
| Dispersent Corexit | 2 | 1 | 0 |
| EC9527A | | | |
| Dispersant Corexit | 1 | 1 | 0 |
| EC9500A | | | |

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims. All patents, patent publications and other documents referred to herein are hereby incorporated by reference in their entirety.

What is claimed is:

1. A method for absorbing an organic liquid, comprising:
providing a polyolefin open cell foam in the form of a sheet, the polyolefin open cell foam having a density less than about 400 mg/cm³ and an average foam pore size in the range of about 0.2 microns to about 20 microns;
contacting the sheet with the organic liquid; and
selectively absorbing the organic liquid into the foam pores.

2. The method according to claim 1, wherein the organic liquid has a Hildebrand solubility parameter δ in the range of about 7.5 (cal^{1/2} cm^{-3/2}) to about 8.5 (cal^{1/2} cm^{-3/2}).

3. The method according to claim 1, wherein the organic liquid has a hydrogen bonding Hansen solubility parameter value that is less than about 20δ/MPa^{1/2}.

4. The method according to claim 1, wherein the organic liquid comprises a hydrocarbon oil.

5. The method according to claim 1, wherein the polyolefin comprises a C₂-C₈ alkene recurring unit.

6. The method according to claim 5, wherein the polyolefin comprises a recurring unit selected from the group consisting of ethylene, propylene, and methylpentene.

7. The method according to claim 1, wherein the polyolefin has a Hildebrand solubility parameter δ in the range of about 7.5 (cal^{1/2} cm^{-3/2}) to about 8.5 (cal^{1/2} cm^{-3/2}).

8. The method according to claim 1, wherein the density of the polyolefin open cell foam is in the range of about 2 mg/cm³ to about 400 mg/cm³.

9. The method according to claim 8, wherein the density of the polyolefin open cell foam is in the range of about 20 mg/cm³ to about 250 mg/cm³.

10. The method according to claim 9, wherein the density of the polyolefin open cell foam is in the range of about 40 mg/cm³ to about 125 mg/cm³.

11. The method according to claim 1, wherein the polyolefin open cell foam has an average foam pore size in the range of about 0.5 microns to about 8 microns.

12. The method according to claim 1, further comprising contacting the sheet with a mixture that comprises the organic liquid and water, wherein the organic liquid is absorbed selectively into the foam pores relative to the water.

13. The method according to claim 12, wherein the sheet absorbs an amount of water that is less than about 5% by weight, based on the weight of the sheet.

14. The method according to claim 12, wherein the sheet absorbs an amount of water that is less than about 1% by weight, based on the weight of the sheet.

15. The method according to claim 12, wherein the sheet absorbs the organic liquid relative to the water with a selectivity greater than about 10 parts organic liquid to 1 part water, by weight.

16. The method according to claim 12, wherein the sheet absorbs the organic liquid relative to the water with a selectivity greater than about 100 parts organic liquid to 1 part water, by weight.

17. The method according to claim 12, wherein the sheet absorbs the organic liquid relative to the water with a selectivity greater than about 300 parts organic liquid to 1 part water, by weight.

18. The method according to claim 12, wherein the organic liquid comprises spilled oil and the water comprises natural water, to thereby treat an oil spill.

19. The method according to claim 1, wherein the sheet has a thickness in the range of about 1 mm to about 25 mm.

20. The method according to claim 12, further comprising delivering the sheet to an oil refinery for recycling the hydrocarbon oil.

21. The method according to claim 12, further comprising burning the sheet for disposal.

22. An oil absorbing device, comprising:
a polyolefin open cell foam in the form of a sheet, the polyolefin open cell foam having a density less than about 400 mg/cm³ and an average foam pore size in the range of about 0.2 microns to about 20 microns, wherein the sheet has a thickness in the range of about 1 mm to about 250 mm; and
a substrate to which the polyolefin open cell foam is affixed, wherein the substrate has a flat two-dimensional configuration having an aspect ratio of at least about 10:1.

23. The device according to claim 22, wherein the sheet is in the form of a plurality of polyolefin open cell foam discs.

24. The device according to claim 23, wherein the plurality of polyolefin open cell foam discs is discontinuous.

25. The device according to claim 22, wherein the substrate has a width in the range of about 1 m to about 20 m.

26. The device according to claim 22, wherein the substrate comprises a net.

27. The device according to claim 22, wherein the polyolefin open cell foam is encapsulated into the substrate.

28. A method for cleaning an oil spill, comprising:
providing an oil absorbing device according to claim 22; and
contacting the oil absorbing device with a mixture that comprises spilled oil and natural water, wherein the polyolefin open cell foam pores selectively absorb the spilled oil relative to the natural water.

29. The method according to claim 28, wherein the oil spill has been previously treated by intermixing a dispersant with the spilled oil, such that the mixture further comprises the dispersant.

30. The method according to claim 29, wherein the polyolefin open cell foam pores selectively absorb dispersants relative to the natural water.

31. A method for storing an organic liquid or wax, comprising:
providing a container comprising a polyolefin open cell foam, the polyolefin open cell foam having a density less than about 400 mg/cm³ and an average foam pore size in the range of about 0.2 microns to about 20 microns; and
placing the organic liquid or wax in the container.
